(19) United States
(12) Patent Application Publication
(10) Pub. No.: US 2003/0236927 A1
(43) Pub. Date: Dec. 25, 2003

(54) Tool for building multiple OS images

(76) Inventors: Christophe Cleraux, Sene (FR); Didier Brachet, Vannes (FR)

Correspondence Address: Davidson, Davidson & Kappel, LLC, 4th Floor, 485 Seventh Avenue, New York, NY, 10018, US

(21) Appl. No.: 10/175,137

(22) Filed: Jun. 19, 2002

(51) Int. Cl. G06F 9/00

(52) U.S. Cl. 709/331

(57) ABSTRACT

A method for building an operating system (OS) image is provided comprising the steps of: building a generic directory with common files, the common files being required for a build of a plurality of configurations; building a configuration directory that mirrors the generic directory, the configuration directory including configuration files that correspond to one of the plurality of configurations; and building an image using the configuration files in conjunction with the common files, the image constructed and arranged to operate a device.

### BACKGROUND

Computer systems typically include software (computer programs) and hardware (the physical components), such as a central processing unit (CPU) that stores and executes software, a monitor to display output and a keyboard and mouse to accept input commands from a user, as a simple example. Complex systems include thousands of computer systems connected by a network with mass storage devices and any number of peripherals,.e.g., printers, scanners, back-up systems, modems.

Software is developed by first writing a program in a programming language, also known as writing source code. The finished source code is translated (e.g., compiled) into a form that is understood by the computer processor. The compiled files are known as object files which are linked to form executable files, the finished end-product program executed by the processor of a computer system.

An operating system is (OS) a collection of programs that allow users to run application software, such as word processors, spreadsheet programs and e-mail software on a specific set of hardware, or platform (e.g. X86 platforms). The operating system acts as an interface between hardware, the users (if any), and software.

When an operating system is installed onto a computer system, it is customized for the platform of that particular system, i.e., desktop, notebook, hand-held, with its specific peripherals (extra components such as printer, scanner, added circuitry for specialized functions like graphics and sound). This process is generally referred to as a “build”. The OS is then stored in binary format, known as an image, on a memory device, such as a hard drive. For example, in Linux, a Unix based OS, the OS is generated by forming a configuration file, setting all the source dependencies (e.g., object files depend on the source files from which they were compiled, and source files may depend on other source files), compiling source code files into object files, and then linking the object files to form an image. A directory source tree is created with all the files needed to build a Linux image capable of performing its desired tasks. The source tree (SRC) includes hundreds of files, including drivers, the source code for the OS, and the libraries. There is only one kernel for each tree and one tree for each image. A single source tree generally includes thousands of files.

### SUMMARY

In accordance with a first embodiment of the present invention, a method for building an operating system (OS) image is provided comprising the steps of: building a generic directory with common files, the common files being required for a build of a plurality of configurations; building a configuration directory that mirrors the generic directory, the configuration directory including configuration files that correspond to one of the plurality of configurations; and building an image using the configuration files in conjunction with the common files, the image constructed and arranged to operate a device.

In accordance with a second embodiment of the present invention, an OS image building tool is provided which comprises a root OS directory and a configuration directory. The configuration directory mirrors the OS root directory. Common files are stored in the root OS directory and these common files are required for a build of a plurality of configurations. Configuration files are stored in the configuration directory and these configuration files correspond to one of the plurality configurations. In accordance with this tool, the configuration files are used in conjunction with the common files to build an OS image for the one of the plurality of configurations, the image constructed and arranged to operate a device.

In accordance with a third embodiment of the present invention, a method for building an OS image comprises the step of accessing a computer readable media having stored thereon: a generic directory with common files, the common files being required for a build of a plurality of configurations; and a plurality of configuration directories, each one of the plurality of configuration directories corresponding to one of the plurality of configurations. Each configuration directory mirrors the generic directory and each configuration directory includes configuration files that correspond to the one of the plurality of configurations. The method further comprises the steps of selecting one of the plurality of configurations, and building the it image using the configuration files for the selected one of the plurality of configurations in conjunction with the common files, the image constructed and arranged to operate a device.

In accordance with a fourth embodiment of the present invention, a method for building an OS image comprises the step of accessing a computer readable media having stored thereon a generic directory with common files, the common files being required for a build of a plurality of configurations, and a configuration directory that mirrors the generic directory, the configuration directory including configuration files that correspond to one of the plurality of configurations. The method further comprises building an image using the configuration files in conjunction with the common files, the image constructed and arranged to operate a device.

In accordance with a fifth embodiment of the present invention, a system for building multiple images is provided. The system includes a processor and a data storage device. The data storage device is operably connected to the processor, and the data storage device includes a program executable by the processor to build a generic directory with common files, the common files being required for a build of a plurality of configurations; build a configuration directory that mirrors the generic directory, the configuration directory including configuration files that correspond to one of the plurality of configurations; and build an image using the configuration files in conjunction with the common files, the image constructed and arranged to operate a device.

### BRIEF DESCRIPTION OF THE DRAWINGS

FIG. 1 depicts a directory tree according to an embodiment of the present invention.

FIG. 2 is a more detailed depiction of the directory tree in FIG. 1 in the context of a Linux OS.

### DETAILED DESCRIPTION OF THE PREFERRED EMBODIMENTS

It is often desirable to have multiple images on one machine to test software for different platforms and hardware configurations. For example, if an application is developed on a host computing environment (e.g., a desktop computer), for use in a target computing environment (e..g., an appliance or a hand-held computer), the host computing environment would have to emulate the target computing environment to test the application being developed. The target computing environment, moreover, may include different configurations. For example, some target computing environments may have different peripherals and functions such as an integrated cellular phone, GPS navigation system, or its display may support SVGA graphics. Each configuration with its own unique peripherals has a corresponding image. Each image has to reside on the host computing environment so that the developed application can be tested for each configuration.

In accordance with an embodiment of the present invention, multiple OS images can be built and reside on the same computer without duplication of source trees to accommodate a variety of system configurations on a single machine. A configuration may, for example, include a particular processor (e.g., on a target computing environment), the drivers that enable a user to handle the hardware associated with the particular processor (e.g., ethernet card, serial interface), and a kernel feature (e.g., file system, TCP/IP stack). A generic directory is provided which contains a source tree that includes common files used for builds of a plurality of configurations. Preferably, the generic directory is read-only to reduce the possibility of corruption. Information unique to each particular configuration is maintained in a mirror source tree in its own individual, separate configuration directory corresponding to that particular configuration. An image can then be built for a particular configuration using the information that configuration's configuration directory in conjunction with the common files in the generic directory. In certain preferred embodiments of the present invention, the operating system is Linux. However, the present invention can be used with other operating systems as well, including for example, BSD/OS or FreeBSD.

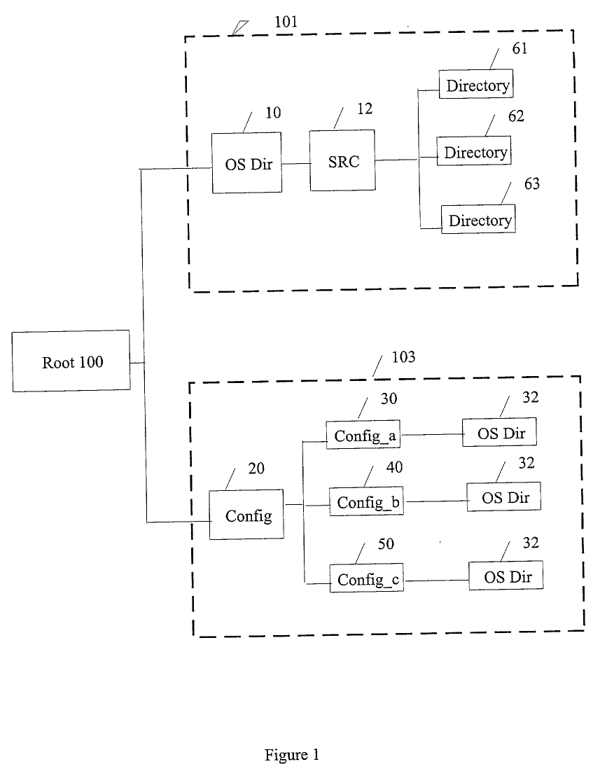

FIG. 1 shows a directory structure according to an embodiment of the present invention. A root directory 100 includes a reference tree 101 and a configuration tree 103. The reference tree 101 includes a generic OS directory 10 that further includes a source (SRC) directory 12 with sub-directories 61-63 for storing, links, drivers, libraries and other files necessary for OS operation. The configuration tree 103 includes configuration sub-directories for corresponding configurations. Config_a sub-directory 30 corresponds to configuration A, Config_b 40 sub-directory corresponds to configuration B and Config_c 50 sub-directory corresponds to configuration C. In each configuration sub-directory is a corresponding OS build directory 32 that contains the unique files for each particular configuration. Moreover, in each configuration sub-directory, the OS build directory 32 mirrors the generic directory 10. In the context of the present invention, one directory “mirrors” another when it contains the same directory structure (e.g., the same sub-directories) as the other directory.

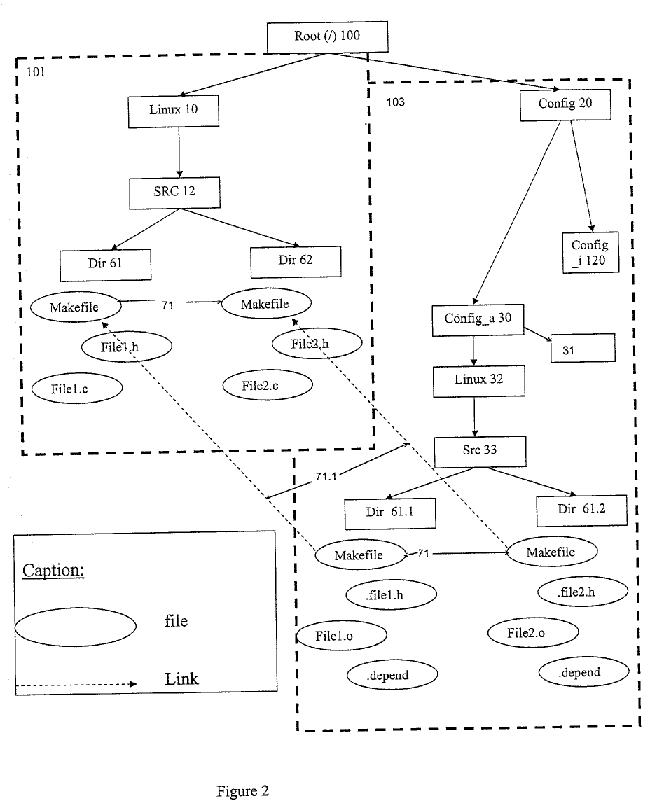

FIG. 2 illustrates the directory structure of FIG. 1 in further detail in the context of a Linux operating system. The root directory 100 includes the reference tree 101 and the configuration tree 103. The reference tree 101 includes the Linux directory 10 and standard SRC directory 12, which further includes hundreds of files comprising drivers, source code for the operating system, and libraries. The SRC directory 12 may be specified as read-only since its contents are not normally modified.

The “Config” directory 20 includes a sub-directory for each configuration (shown as config_a 30 through config_i 120 in FIG. 2). An “empty” configuration source tree (src 33) with the directory names of the SRC 12 and links 71 for the makefiles 71 in SRC 12 is in each “mirror” OS build directory (Linux 32). Each sub-directory 30 includes the “.config” file 31 for its corresponding configuration. As one of ordinary skill in the art will appreciate, the “.config” file is unique to each configuration. For example, a configuration with NFS support will have a different “.config” file than a configuration without NFS support. The “.config” file 31 for each configuration is stored in its corresponding directory so that “.config” files are not overwritten every time an image is built. This allows multiple “.config” files 31 to be used and re-used.

When a user wishes to build an image corresponding to a configuration, the system uses the information in the “.config” file stored in the sub-directory 30 for that configuration to generate corresponding object and header files for that configuration. The object and header files are stored in the corresponding empty source directory (src 33) in the same location where they would ordinarily be stored in the main source directory (SRC 12) of the reference tree 101.

For example, the sub-directory config_a 30 mirrors the reference tree 101. The directories are structured the same and files are stored in the same locations in the directory structure. In this regard, the Linux 32 directory in config_a 30 mirrors the Linux 10 directory in the reference tree 101. The SRC 12 directory in the reference tree 101 is mirrored by a corresponding src 33 directory in the config_a 30 directory. Dir_{—}1 61 and Dir_{—}2 62 in reference tree 101 are mirrored by sub-directories 61.1 and 62.1 of the same name in the config_a directory 30. The generic names “Dir 1” and “Dir2” were chosen to exemplify the fact that these subdirectories may contain any type of data and structure. In addition, corresponding links 71.1 are provided in the config_a directory 30 for makefile's 71 in the reference tree 101. Dependencies (rules that indicate if a target file should be updated when another file is modified) are tracked in “.depend” files in the src 33 directory, as discussed in more detail below. It should be noted that source files (e.g., files with a “.c” extension) that are generic to all configurations, are maintained only in the SRC 12 directory, whereas the object files (e.g., files with a “.o” extension), which are unique to each configuration, are only maintained in the src 33 directory for its corresponding configuration. The header files (e.g., files with “.h” extension) in the SRC 12 directory (e.g., File1.h) are mirrored in src 33 (e.g, “File1.h” is mirrored as “.file1.h”) for reasons which are explained in more detail below.

In certain embodiments of the present invention, source files (e.g., “.c” files) that are unique to a particular configuration are stored in the src 33 directory, whereas source files which are common to all configurations are maintained in the SRC 12 directory.

The tree directory structures set forth above can be implemented by changing various Linux build commands. An exemplary set of changes to the Linux build commands that may be used in accordance with the embodiments of the present invention are:

1. Adding a vpath command to indicate the path for the source files (C, assembler and header files). This can be be readily implemented, for example, with a script.

2. Replacing hardcoded file names with automatic variables ($@ and $<). It should be noted that many prior art Linux Makefiles also use such automatic variables.

3. Replacing hardcoded references to header files with automatic variables (because the header files are no longer located in the build tree but in the source tree).

4. Modify the dependency mechanism.

For example, a typical Linux build command is:

| | |
|---|---|
| myfile.o: | myfile.c $(TOPDIR)/include/linux/types.h |
| | ${CC) ${CFLAGS} -o myfile.o myfile.c |

The first argument in the command, “myfile.o,” is the name given to the object file that will result from compiling “myfile.c” using the command in the second line “${CC) $ {CFLAGS}-o myfile.o myfile.c”. The file “myfile.o”, will be built at the time of the initial build and will be rebuilt each time its source file “myfile.c” or the header file “$(TOPDIR)/include/linux/types.h” are modified. CC and CFLAGS are build macros that are set according to the build environment. “TOPDIR” represents the top of the Linux reference tree (e.g., Linux 10).

According to an embodiment of the present invention, the above Linux build command is modified as follows:

# Automatically added lines do not edit
vpath %.c $ {RPATH}/drivers/char
vpath %.S $ {RPATH}/drivers/char
vpath %.h $ {RPATH}/drivers/char:${RPATH}/include
myfile.o: myfile.c $(RPATH}/include/linux/types.h

$(CC) ${CFLAGS}-c -o $@$<

In the above modified build command, the “vpath” commands indicate the path for the source files using the RPATH variables, which point to SRC 12, the base of the source reference tree 101. From the original build command, the hardcoded file names “myfile.o” and “myfile.c” are replaced with automatic variables “$@” and “$<”, respectively. Hardcoded references to header files are replaced with automatic variables as well.

As one of ordinary skill in the art will appreciate, the modified build commands set forth above are merely exemplary of a variety of techniques for implementing the above-referenced embodiments. In any event, regardless of which particular technique is used to generate the build, an OS image is generated utilizing the source files (e.g., “.c” files, such as myfile.c above) and other generic files from the SRC 12 and the “.config” file from the directory 30, to generate the corresponding object files (“.o” files, such as myfile.o above) and header files (“.h” files, such as “.file1.h” above) for that configuration. As noted above, the generated “.o” and “.h” files are stored in the src 33 directory for the configuration.

As indicated above, files built from source files (such as object files or other source files) are said to depend on those source files. These dependencies are tracked so that when a source file is modified or updated, its dependent files are modified or updated as well. Preferably, the dependencies for all files in the OS build directories are calculated and stored in several “depend” files, such as the “.hdepend” file for header files and the “.depend” file for object files, shown below in Table 1. In each case, the file on top (the file preceding the colon) depends on the files listed below it. Therefore, the top file needs to be updated if either of the files beneath it are updated. For example, if either file4.h or file5.h have been updated, then file2.h is updated using the “@touch” command at the end of the file2.h dependency definition. Moreover, once file2.h has been updated, then file1.h will be updated using the “@touch” command at the end of the file1.h dependency definition. Then, the dependencies for the .h and .c files are generated in the SRC 12 directory, and are stored in “.depend files”. In this manner, when file1.o is built, the system detects that there is a dependency on file1.h and, via the .hdepend file, the dependencies on file2.h, file3.h, file4.h, and file5.h are also detected.

TABLE 1

.depend file
file1.o: file1.c

file1.h

.hdepend file
fue1.h:

file2.h
file3.h
@touch file1.h

file2.h:
file4.h
file5.h
@touch file2.h

When a build is proceeding, the system checks to see that no file being used is older than a file upon which it depends. The use of the “@ touch” command in each dependency generation prevents multiple re-builds from being required. For example, if file2.h is updated during a first build, the system will determine that file1.o must be rebuilt because file2.h is newer than file1.o. However, without the “@touch” commands in Table 1, file1.h would not a_m have been updated. Therefore, when the build is run again, file2.h will be newer than file1.h, and yet another rebuild of file1.o will be required. By using the “@touch” command in the last line of each dependency definition, this problem is eliminated.

The problem with the “@touch” command is that, in accordance with the preferred embodiment of the present invention described above, the reference tree 101 is read-only and, as a result, the “@ touch” command will be unable to update the “.h” file in the source tree 12. To address the problem, the dependency generation is modified in accordance with a preferred embodiment of the present invention by creating an intermediate file located in the src 33 directory. In this example, the intermediate file begins with a period (e.g., “.file1.h”) to make it invisible when the user runs on “ls” command. The new dependencies are shown in Table 2.

TABLE 2

| .depend | |
|---|---|
| File1.o: | file1.c |
| | .file1.h |
| .hDepend File | |
| fuel .h: | <RPATH>/file1.h |
| | .file2.h |
| | .file3.h |
| | @touch.file1.h |
| .file2.h: | <RPATH>/file2.h |
| | .file4.h |
| | .file5.h |
| | @touch .file2.h |

In accordance with the above “.depend” file, if file2.h from SRC 12 is updated, the .o file is built because it depends on the “.file1.h” file (in src 33) which, in turn, depends both on “file1.h” (in SRC 12) and “.file2.h” (in src 33), which in turn depends on “file2.h” (in SRC 12). When the build is done, the “.file1.h” file is updated with the touch command. On the second build, no dependency is detected (“.file1.h” is older than file1.o) and no build is done. Since the “file1.h” file was never modified, the build will not have an impact on any future build in another configuration.

In any event, when an OS is built for a specific configuration, files which are generic to all configurations (including, for example, source files, certain header files, libraries, etc.) are stored in the Linux 10 directory and its sub-directories. Files unique to a particular configuration (including “.config” files, object files, “.depend” files, “.hdepend” files, certain header files, etc.) are stored in the “mirror” tree (Linux 32 and its sub-directories) for that configuration, in the same directory structure as in a conventional Linux build. For example, the built objects are stored in the Linux build directory 32 for that configuration (rather than Linux directory 10) and the ‘.config’ file containing the configuration for the OS and the and the OS image generated for this configuration are stored in the configuration directory 30 rather than root directory 100.

As noted above, in certain embodiments, source files specific to a particular configuration may be included in the tree 103. This feature is useful, for example, if a user wishes to make modifications to the source code for the OS in order to perform a test, but wishes to be able to return to the prior version of the source code at a later time. As an example, if a user wants to modify a file from the Linux kernel (such as a “.c” file) to do a test, the user simply places the modified file in the location in the mirror tree that corresponds to the original file's location in the reference tree 101. When the build runs, it will first look in the mirror tree (Linux 32 and its subdirectories) to find source and header files. Any source or header files found in the mirror tree will be used. If a source or header file is not found in the build directory, it will take those files from the reference tree (e.g., Linux 10 and its subdirectories). In the exemplary Linux build command code set forth above, the “vpath” command is responsible for this functionality by providing the alternate directory to look for a specific file. In accordance with this exemplary code, the current directory (SRC 33) is first searched, and if the desired file cannot be found, then the directory specified by the “vpath” command, (in this example, RPATH (SRC 12)) is searched. This feature is particularly useful if one or more users wish to be able to modify a file, but do not wish this modification to affect other configurations. For example, in a multiple user environment, user 1 may wish to modify the source files for an OS without affecting user 2, who may wish to use the original unmodified version.

A wide variety of techniques can be used to allow a user to select a configuration for use. When the system boots up, for example, the user may be provided with a selection menu containing all the available configurations. Selection may be made by entering certain text corresponding to a configuration, or by clicking on the selection in a graphical user interface (GUI) environment. In addition, a default selection may be made automatically for the user after a certain amount of time expires.

As another example, consider the case of a client-server architecture. A server may be provided with applications and data for a number of users, and connected to a number of clients via a communications network. Each user works on a client machine and has a corresponding profile on the server that contains the user's preferences including the particular configuration and image for that user's client machine. The user logs onto (accesses) the network with his client machine by communicating with the server via the network and requesting access to the network resources, i.e., applications and data. The server acts on the request by checking whether the user is allowed access and if so, accesses the user profile and establishes a communication link with the client for transferring client components of the network resources to the client machine. When the client components are transferred, the corresponding image information is transferred as well, and that configuration is downloaded to the client for use.

A combination of the above methods may also be provided. For example, in a client-server environment, an image server may store all the images and when a user logs onto the server, he may make his selection by a user menu. Or, the BIOS file may be modified to work with the server in loading the appropriate image optimized to run a particular client machine.

In the preceding specification, the invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A method for building an OS image comprising the steps of:
building a generic directory with common files, the common files being required for a build of a plurality of configurations;
building a configuration directory that mirrors the generic directory, the configuration directory including configuration files that correspond to one of the plurality of configurations;
building an image using the configuration files in conjunction with the common files, the image constructed and arranged to operate a device.

2. The method of claim 1, wherein the image is a Linux image.

3. The method of claim 1, wherein the image is a BSD/OS image.

4. The method of claim 1, wherein the image is a FreeBSD image.

5. The method of claim 1 wherein
the step of building a configuration directory further comprises the step of building a plurality of configuration directories, each one of the plurality of configuration directories corresponding to a pre-determined configuration;
wherein, the method further comprises selecting one of the plurality of configurations; and
wherein, the building step comprises building the image using the configuration files for the selected one of the plurality of configurations.

6. The method of claim 1, wherein the generic files include drivers, libraries, and OS source code.

7. The method of claim 1, wherein the configuration files include header files and object files.

8. A operating system (OS) image builder comprising:
an root OS directory;
a configuration directory mirroring the OS root directory;
common files stored in the root OS directory, the common files being required for a build of a plurality of configurations;
configuration files stored in the configuration directory, the configuration files corresponding to one of the plurality configurations;
wherein the configuration files are used in conjunction with the common files to build an OS Linux image for the particular configuration, the OS image constructed and arranged to operate a device.

9. The image builder of claim 8, wherein the OS image is a Linux image.

10. The image builder of claim 8, wherein the OS image is a BSD/OS image.

11. The image builder of claim 8, wherein the OS image is a FreeBSD image.

12. The image builder of claim 8, wherein the common files include drivers, libraries, and OS source code.

13. The image builder of claim 8, wherein the configuration files include header files and object files.

14. The image builder of claim 8 wherein the configuration directory further comprises:
a parent configuration directory with a plurality of configuration sub-directories, each of the configuration sub-directories having a mirror directory of the root OS directory and a set of corresponding, configuration files for a respective one of the plurality of configurations.

15. A system for building multiple images comprising:
a processor; and,
a data storage device operably connected to the processor, the data storage device including a program executable by the processor to:
build a generic directory with common files, the common files being required for a build of a plurality of configurations;
build a configuration directory that mirrors the generic directory, the configuration directory including configuration files that correspond to one of the plurality of configurations;
build an image using the configuration files in conjunction with the common files, the image constructed and arranged to operate a device.

16. The system of claim 15, wherein the image is a Linux image.

17. The system of claim 15, wherein the image is a BSD/OS image.

18. The system of claim 15, wherein the image is a FreeBSD image.

19. The system of claim 15 wherein
the program executable by the processor to build the configuration is executable by the processor to build a plurality of configuration directories, each one of the plurality of configuration directories corresponding to a respective one of the plurality of configurations;
wherein, the program is executable by the processor to select one of the plurality of configurations; and
wherein, the program executable by the processor to build the image is executable by the processor to build the image using the configuration files for the selected one of the plurality of configurations.

20. The system of claim 15, wherein the common files include drivers, libraries, and OS source code.

21. The system of claim 15, wherein the configuration files include header files and object files.

22. A method for building an OS image comprising the steps of:
accessing a computer readable media having stored thereon a generic directory with common files, the common files being required for a build of a plurality of configurations, and a configuration directory that mirrors the generic directory, the configuration directory including configuration files that correspond to one of the plurality of configurations;
building an image using the configuration files in conjunction with the common files, the image constructed and arranged to operate a device.

23. The method of claim 22, wherein the image is a Linux image.

24. The method of claim 22, wherein the image is a BSD/OS image.

25. The method of claim 22, wherein the image is a FreeBSD image.

26. The method of claim 22, wherein the common files include drivers, libraries, and OS source code.

27. The method of claim 22, wherein the configuration files include header files and object files.

28. A method for building an OS image comprising the steps of:
accessing a computer readable media having stored thereon: a generic directory with common files, the common files being required for a build of a plurality of configurations; and a plurality of configuration directories, each one of the plurality of configuration directories corresponding to a predetermined configuration, each configuration directory being a mirror of the generic directory, each configuration directory including configuration files that correspond to a respective one of the plurality of configurations;
selecting one of the plurality of configurations; and
building the image using the configuration files for the selected one of the plurality of configurations in conjunction with the common files, the image constructed and arranged to operate a device.

29. The method of claim 28, wherein the common files include drivers, libraries, and OS source code.

30. The method of claim 28, wherein the configuration files include header files and object files.

31. The method of claim 28, wherein the image is a Linux image.

32. The method of claim 28, wherein the image is a BSD/OS image.

33. The method of claim 28, wherein the image is a FreeBSD image.
